(19) United States
(12) Patent Application Publication
(10) Pub. No.: US 2004/0009605 A1
(43) Pub. Date: Jan. 15, 2004

(54) Method for the detection of volatile organic compounds using a catalytic oxidation sensor

(75) Inventors: Kenneth G. Brown, Norfolk, VA (US); Donald M. Oglesby, Virginia Beach, VA (US); Bradley D. Leighty, Gloucester, VA (US); Erik J. Kielin, Alexandria, VA (US); David R. Schryer, Hampton, VA (US); Billy T. Upchurch, Virginia Beach, VA (US)

Correspondence Address: NATIONAL AERONAUTICS AND SPACE ADMINISTR, ATION LANGLEY RESEARCH CENTER, 3 LANGLEY BOULEVARD, MAIL STOP 212, HAMPTON, VA, 236812199

(73) Assignee: U.S. as represented by the Administrator of the National Aeronautics & Space Administration, Washington, DC

(21) Appl. No.: 10/601,801

(22) Filed: Jun. 20, 2003

Related U.S. Application Data
(62) Division of application No. 09/607,212, filed on Jun. 30, 2000, now abandoned.
(60) Provisional application No. 60/141,729, filed on Jun. 30, 1999.

(51) Int. Cl. G01N 27/00

(52) U.S. Cl. 436/149; 422/94

(57) ABSTRACT

A means for detecting volatile organic compounds which utilizes a catalytic material to oxidize volatile organic compounds at temperatures substantially lower than the autoignition temperature of the compound. Because this reaction is exothermic, a thermistor in contact with the catalytic material is used to detect the heat evolved as volatile organic compounds are oxidized to carbon dioxide and water at the catalyst surface. Upon comparison to a reference thermistor, relative increases in the temperature of the sensing thermistor correspond positively with an increased concentration of volatile organic compounds and are thus used as an indicator of the presence of such compounds.

### DROSS-REFERENCE TO RELATED APPLICATION

This application is a divisional patent application of commonly owned, co-pending patent application Ser. No. 09/607,212, filed Jun. 30, 2000, which, pursuant to 35 U.S.C. §119, claims the benefit of priority from provisional application 60/141,729, filed Jun. 30, 1999.

### ORIGIN OF THE INVENTION

The invention described herein was jointly made by employees of the United States Government and contract employees during the performance of work under a NASA contract which is subject to the provisions of Public Law 95-517 (35 U.S.C. §202) in which the contractor has elected not to retain title.

### BACKGROUND OF THE INVENTION

The current invention pertains generally to the field of sensors used in the detection of hydrocarbons and other volatile organic compounds. In particular, this invention pertains to the use of a platinized tin-oxide catalyst in a sensor which detects the presence of hydrocarbons and other volatile organic compounds in the atmosphere or other oxidant-containing medium.

The ability to detect the presence of volatile organic compounds in environmental spaces, such as homes and automobiles, is very important. Public awareness of this problem has produced a great demand for low priced volatile organic compounds sensing devices. Sensors currently available on the market, however, operate at very high temperatures and do not have the capability of specificity as they respond to a large number of species. These high operational temperatures (500-1000° C.) are above the autoignition temperatures of many combustible media and thus create a safety hazard which must be addressed in the design of the sensor and instrumentation. Spectrometric methods often require large and sophisticated instrumentation and are inherently expensive.

For the foregoing reasons, there is a need for a simple, low cost, low power volatile organic compound detector which operates at temperatures substantially lower than the autoignition temperature of the compound. It is a primary object of the present invention to provide a volatile organic compound detector which exhibits these properties, as well as a faster response time than any other simple point-source sensors.

### SUMMARY OF THE INVENTION

The present invention is directed towards a simple, low cost volatile organic compound sensor which rapidly detects the presence of volatile organic compounds at temperatures substantially lower than the autoignition temperature of the compound. A volatile organic compound detector having features of the present invention comprises a catalytic material which achieves oxidation of the compound to carbon dioxide and water at low temperatures. The catalytic material which facilitates oxidation in the present invention is from a class of catalytic materials comprising one or more noble metals in combination with a suitable reducible oxide. Since this chemical reaction is exothermic, heat generated upon the oxidation of volatile organic compounds at the catalyst surface can be detected by a sensing element in contact with the catalytic material. An increase in temperature, and thus conductance, of the sensing element in relation to a reference element then serves as an indicator of the presence of hydrocarbons and other volatile organic compounds. Hydrocarbons include, but are not limited to, methane and other saturated and unsaturated volatile hydrocarbon compounds. Other volatile organic compounds include, but are not limited to, alcohols, aldehydes, ketones, and other aromatic and non-aromatic compounds.

### BRIEF DESCRIPTION OF THE DRAWING

These and other features, aspects, and advantages of the present invention will become better understood with regard to the following description, appended claims, and accompanying drawing where:

FIG. 1 shows the volatile organic compound sensor.

### DETAILED DESCRIPTION OF THE INVENTION

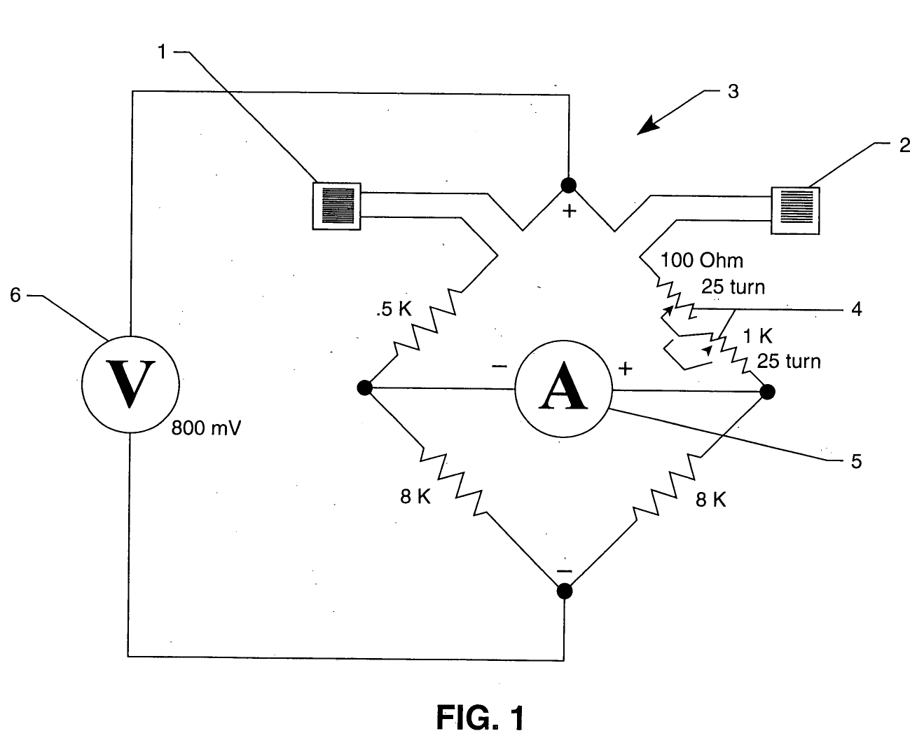

As shown in FIG. 1, a volatile organic compound sensor comprises a reference thermistor 1 and a sensing thermistor 2 which are attached to opposite legs of a Wheatstone bridge circuit 3. The reference thermistor 1 comprises an uncoated 8 kilo-Ohm precision thermistor which is used in the reference leg of the Wheatstone bridge circuit 3 to cancel out any changes in room or gas temperature. The sensing thermistor 2 comprises an 8 kilo-Ohm precision thermistor which is surrounded by a catalytic material which exothermically oxidizes volatile organic compounds to carbon dioxide and water at temperatures substantially lower than the autoignition temperature of the compound. Two trim potentiometers 4 were added to the leg of the bridge circuit containing the sensor to compensate for any differences between the reference and the sensing thermistors.

Within said Wheatstone circuit 3, a nano-ammeter 5 serves to measure the bridge imbalance which occurs upon the change in temperature of the sensing thermistor 2 in relation to the reference thermistor 1. A DC voltage calibrator 6 with a stability of ±10 microvolts is used to apply a signal of 800 millivolts across the Wheatstone bridge circuit.

When in operation, the two thermistors, 1 and 2, remain exposed to the environment of interest so they may respond to concentrations of volatile organic compounds and temperature changes. In the presence of volatile organic compounds, the sensing thermistor increases in temperature relative to the reference thermistor due to the exothermic nature of the oxidation of volatile organic compounds. Upon an increase in the temperature of the sensing thermistor in relation to the reference thermistor, the two legs of the bridge circuit exhibit different resistances, which generates an electrical current in the Wheatstone bridge circuit 3. The presence and intensity of these currents are detected and reported by the nano-ammeter 5, which thus indicates the presence of volatile organic compounds in the ambient medium.

In a preferred version of the present invention, the catalytic material in contact with the sensing thermistor comprises one or more noble metals combined with a reducible oxide. In particular, the sensor is used is based on platinized tin-oxide (Pt/SnO₂), which is the subject of U.S. Pat. Nos. 4,885,274; 4,912,082; and 4,991,181.

There are many ways in which the method of contact between the sensing thermistor and the catalytic material may be changed within the basic concept of the present invention. In the following example, the sensing thermistor 2 was fabricated by inserting the thermistor leads into a teabag filled with powdered catalyst material and sealing the bag. However, many other methods for obtaining a high active catalyst surface area in close proximity to the thermistor are also being evaluated.

### EXAMPLES

The following examples demonstrate various operating temperatures of the present sensor. These examples can be found in U.S. Pat. No. 6,132,694, incorporated by reference herein.

1. Test Results for C₁ to C₅ Straight-Chain Hydrocarbons

In a test according to the present invention, the non-branched, saturated C₁ to C₅ hydrocarbons were oxidized over both promoted and unpromoted Pt/SnO₂-based catalysts. The C₁ to C₅, HC test gases were in concentrations of approximately 1000 ppm in Ultra Zero Air. Each was a gravimetric standard.

TABLE ONE

| Hydrocarbon | Concentration |
|---|---|
| methane | 969 ppm |
| ethane | 984 ppm |
| propane | 996 ppm |
| butane | 975 ppm |
| pentane | 1000 ppm |

Each catalyst sample was held in a reactor made of ⅜″ o.d. stainless steel tubing bored out slightly to accept a catalyst piece ¾″ to 1″ in length, such that no quartz wool support was necessary. The weight of each such piece was 0.4 to 0.5 grams of which about 22% was catalyst coating thus giving about 90 to 100 mg of catalyst.

The catalyst was exposed to nitrogen or air in order to establish a baseline at 35° C. (0 ppm HC). The air stream was switched to the HC test gas and allowed to equilibrate until a stable line was obtained indicating the total unconverted HC concentration. The temperature was incremented at 2° C. per minute for 5 minutes (10° C. total) and then held for 15 minutes to allow desorption and equilibration. The temperature was ramped from 35° C. up to a temperature high enough to completely oxidize the HC, anywhere from 190° C. to 280° C. depending on the HC. The temperature was held for 15 minutes and then the system was cooled back to 35° C.

Desorption was observed as the temperature was initially increased from 35° C. to between 80° C. and 120° C, at which point oxidation was initiated for all hydrocarbons and little desorption was observed. The light-off temperature ranged from about 150° C. for hexane to 220° C. for methane. The greater the number of carbon atoms per molecule, the more easily the hydrocarbon oxidized and consequently the lower the temperature range over which oxidation occurs. The complete oxidation occurred at temperatures well below the autoignition temperature (309° C. for pentane to 537° C. for methane) of each hydrocarbon.

2. Test Results for Alcohols

In another test according to the present invention, less than 100 mg of catalyst (14% Pt/SnO₂) at 29±1° C. oxidized about 6500 ppm of methanol to CO₂ over an oxygen concentration range of 20% down to near stoichiometry at which point the catalyst activity decreases.

For ethanol, oxidation began at a catalyst temperature of about 30° C. or lower, by 125° C., the ethanol was completely oxidized.

For propanol, oxidation began at a catalyst temperature of about 50° C. or lower, by 120° C., the propanol was completely oxidized.

For isopropyl alcohol, oxidation began at a catalyst temperature of 100° C.

What is claimed is:

1. A method for detecting the presence of at least one volatile organic compound at a temperature lower than the autoignition temperature of said at least one compound in a heated oxidant-containing media comprising the steps of:
providing a sensor comprising an uncoated reference thermistor and a coated sensing thermistor;
presenting the sensor to the at least one volatile organic compound in the heated oxidant-containing media, and thereby heating the sensor; and
measuring the change in temperature of the coated sensing thermistor as compared to the temperature of the reference thermistor, as the at least one volatile organic compound is converted into carbon dioxide and water.

2. The method of claim 1 wherein said coating on said sensing thermistor comprises a catalyst comprising one or more noble metals combined with a reducible oxide.

3. The method of claim 1 wherein said coating on said sensing thermistor comprises a catalytic material in powdered, granular, or monolithic form.

4. The method of claim 1 wherein said at least one volatile organic compound is selected from the group consisting of hydrocarbons and oxygen-containing compounds.

5. The method of claim 1 wherein said at least one volatile organic compound is selected from the group consisting of methane, ethane, propane, butane, pentane, alcohol, ketone, ether, epoxide, aldehyde, and carboxylic acid.

6. The method of claim 1 wherein the alcohol is selected from the group consisting of methanol, ethanol, propanol, and isopropyl alcohol.

7. The method of claim 1, wherein the reference thermistor is an uncoated 8 kilo-Ohm thermistor and the coated sensing thermistor is a 8 kilo-Ohm thermistor, and the coating on said coated sensing thermistor comprises a catalytic material which exothermically oxidizes volatile organic compounds to carbon dioxide and water.

8. The method of claim 7 wherein catalytic material comprises one or more noble metals combined with a reducible oxide.

9. The method of claim 7 wherein said catalytic material in powdered, granular, or monolithic form.

10. A method for detecting the presence of at least one volatile organic compound at a temperature lower than the autoignition temperature of said at least one compound in a heated oxidant-containing media comprising the steps of:
providing a heated sensor comprising an uncoated reference thermistor and a coated sensing thermistor;
presenting the heated sensor to one of the at least one volatile organic compound in a heated oxidant-containing media and the at least one volatile organic compound in an unheated oxidant-containing media; and
measuring the change in temperature of the coated sensing thermistor as compared to reference thermistor, as the at least one volatile organic compound is converted into carbon dioxide and water.

11. The method of claim 10 wherein said coating on said sensing thermistor comprises a catalyst comprising one or more noble metals combined with a reducible oxide.

12. The method of claim 10 wherein said coating on said sensing thermistor comprises a catalytic material in powdered, granular, or monolithic form.

13. The method of claim 10 wherein said at least one volatile organic compound is selected from the group consisting of hydrocarbons and oxygen-containing compounds.

14. The method of claim 10 wherein said at least one volatile organic compound is selected from the group consisting of methane, ethane, propane, butane, pentane, alcohol, ketone, ether, epoxide, aldehyde, and carboxylic acid.

15. The method of claim 10 wherein the alcohol is selected from the group consisting of methanol, ethanol, propanol, and isopropyl alcohol.

16. The method of claim 10, wherein the reference thermistor is an uncoated 8 kilo-Ohm thermistor and the coated sensing thermistor is a 8 kilo-Ohm thermistor, and the coating on said coated sensing thermistor comprises a catalytic material which exothermically oxidizes volatile organic compounds to carbon dioxide and water.

17. The method of claim 16 wherein said coating on said sensing thermistor comprises a catalyst comprising one or more noble metals combined with a reducible oxide.

18. The method of claim 16 wherein said coating on said sensing thermistor comprises a catalytic material in powdered, granular, or monolithic form.
